(19) United States
(12) Patent Application Publication
(10) Pub. No.: US 2015/0006287 A1
(43) Pub. Date: Jan. 1, 2015

(54) ADVERTISING INFRASTRUCTURE SUPPORTING VIRTUAL TAG ACTIVATION RANGING AND TRIGGERS

(71) Applicant: Broadcom Corporation, Irvine, CA (US)

(72) Inventors: Wael William Diab, San Francisco, CA (US); Yasantha Nirmal Rajakarunanayake, San Ramon, CA (US)

(73) Assignee: Broadcom Corporation, Irvine, CA (US)

(21) Appl. No.: 13/931,885

(22) Filed: Jun. 29, 2013

Related U.S. Application Data
(60) Provisional application No. 61/841,239, filed on Jun. 28, 2013.

(51) Int. Cl. G06Q 30/02

(52) U.S. Cl. CPC G06Q 30/0261; G06Q 30/0256; G06Q 30/0273
USPC 705/14.54

(57) ABSTRACT

Advertising revenue models applied to geolocation virtual tag infrastructures. In various embodiments, a fee-based activation area is established for delivery and display of a virtual tag that includes advertising information from a merchant or service provider located within the activation area. The advertising virtual tag may be displayed automatically when an appropriately configured device enters the activation area. In other embodiments, the advertising virtual tag is delivered by an advertising server to a mobile device for presentation in conjunction with search results corresponding to a search query received from the mobile device. A poster may select various options (with associated fees) for preferential treatment of the advertising virtual tag. Such options can include, for example, prioritized ranking in a listing of search results or virtual tags, expanded activation range(s), extended time duration for activation, etc.

### CROSS REFERENCE TO RELATED PATENTS/PATENT APPLICATIONS

### Provisional Priority Claims

The present U.S. Utility Patent Application claims priority pursuant to 35 U.S.C. §119(e) to the following U.S. Provisional Patent Application which is hereby incorporated herein by reference in its entirety and made part of the present U.S. Utility Patent Application for all purposes:

1. U.S. Provisional Patent Application Ser. No. 61/841,239, entitled “ADVERTISING INFRASTRUCTURE SUPPORTING VIRTUAL TAG ACTIVATION RANGING AND TRIGGERS,” filed Jun. 28, 2013, pending.

### BACKGROUND

1. Technical Field

The invention relates generally to Internet-based advertising and, more particularly, it relates to use of geolocation-based virtual tagging for advertising purposes.

2. Description of Related Art

Providers of advertisements have used the Internet for many years to deliver advertisements tailored to users of computers and other devices. Many World Wide Web (“web”) search engine providers are commercial ventures supported by advertising revenue. For example, search engines often couple advertisements with search results in an attempt to cause users to click upon the advertisements (“ads”) to purchase products and services. An advertiser may pay a fee to have its listings ranked higher in search engine result pages. Likewise, search engines may run search related ads alongside regular search results, and then collect money every time someone clicks on one of these ads. Other methods of online advertising, including paid placement (e.g., banner ads), contextual advertising, and social network advertising may be employed to market and promote products and services. In the U.S. alone, it is estimated that annual online advertising revenues now surpass thirty billion dollars. Such revenues have contributed greatly to the build out of convention web-hosted search and advertising infrastructures.

Today, a large amount of Internet-based searching is performed using portable or hand-held mobile communication devices. These devices are often equipped with Global Positioning System (GPS) sensors that provide the user with access to web-based information and search query results based on their physical proximity. In a process called geo-tagging, information (e.g., photos, videos, and other forms of media) can be provided along with geospatial metadata. While this data typically comprises latitude and longitude coordinates, it may also include location names and altitude, bearing, distance, and like data. Recent technological improvements have enhanced the interaction between such geo-tagged information and mobile communication devices.

### BRIEF DESCRIPTION OF THE SEVERAL VIEWS OF THE DRAWINGS

FIG. 1 shows a system diagram of an example system connecting a number of different devices and a target object via a tag-based advertising search engine.

FIG. 2 is a block diagram of an exemplary search system including virtual tagging capabilities.

FIG. 3 shows an exemplary scenario for receiving advertising virtual tags based on geo-proximity to a posting target.

FIG. 4 is a block diagram of an exemplary virtual tag-based advertising system that supports fee-based activation ranging and triggering.

FIG. 5 is an operational flow diagram illustrating an exemplary method for activating an advertising virtual tag for presentation with search query results.

FIG. 6 is an operational flow diagram illustrating an exemplary method for proximity-based activation of an advertising virtual tag by an advertising server.

FIG. 7 is a system diagram of an example scenario in which advertising virtual tags for merchant locations are ordered according to associated advertising fees.

FIG. 8 is a screen shot illustrating an example advertising virtual tag posting interface.

FIGS. 9 and 10 are screen shots illustrating an exemplary virtual tag search interface.

### DETAILED DESCRIPTION

In various embodiments of the technology described herein, virtual tag-based advertising infrastructure and methodologies are provided to support revenue models based on geo-proximity of mobile searching devices. In some embodiments, a fee-based activation area is established for delivery and display of a virtual tag that includes advertising information from a merchant or service provider located within the activation area. The advertising virtual tag may be displayed automatically when an appropriately configured device enters the activation area.

In other embodiments, the advertising virtual tag is delivered by an advertising server to a mobile device for presentation in conjunction with search results corresponding to a search query received from the mobile device. A poster may select various options (with associated fees) for preferential treatment of the advertising virtual tag. Such options can include, for example, prioritized ranking in a listing of search results or virtual tags, expanded activation range(s) for a virtual tag, extended time durations for activation of a virtual tag, etc.

The embodiments described below may be practiced in a variety of networks that utilize wired, wireless or optical connections, or any combinations thereof. For example, the illustrated communication links may utilize one or more of various transmission media—such as coaxial cable, shielded twisted pair cable, fiber-optic cable, power line wires, and wireless media (radio frequencies, microwave, satellite, infrared, etc.)—and operate in accordance with a variety of communication and networking protocols (TCP/IP, UPnP, IPv6, etc.) and standards (3G, 4G, IMT-Advanced, DOCSIS, xDSL, Wi-Fi/802.11x, WiMax, Bluetooth, etc.). In addition, the communication links may comprise a picocell, femtocell, metrocell, heterogeneous network (HetNet) and/or multi-hop network utilizing a spanning tree protocol, direct wireless connections, peer-to-peer links, etc. One or more of such networks may include the Internet and/or the World Wide Web (“web”), and may be public, private, virtual or any combination thereof.

Further, while various devices (such as mobile phones, tablet computers, personal computers (PCs)) are described, other devices not described herein may be used in the interactions described in this disclosure. In addition, although implementation examples are noted herein, the implementation is not limited to such disclosed embodiments.

Briefly, virtual tagging in accordance with the disclosure provides users with the ability to create geolocation virtual tags for various target objects and locations throughout the world. A geolocation virtual tag (virtual tag) might include, for example, a text note on a hiking trail advertising a local café, an advertisement from a business in close proximity to the user, a text note praising a restaurant, a photo taken atop the Eiffel Tower at night, a vacation video and text note, or the like. Each of such virtual tags, upon posting, receives an associated geolocation. A supporting infrastructure may store each virtual tag posting element along with its associated geolocation for access by searching infrastructures.

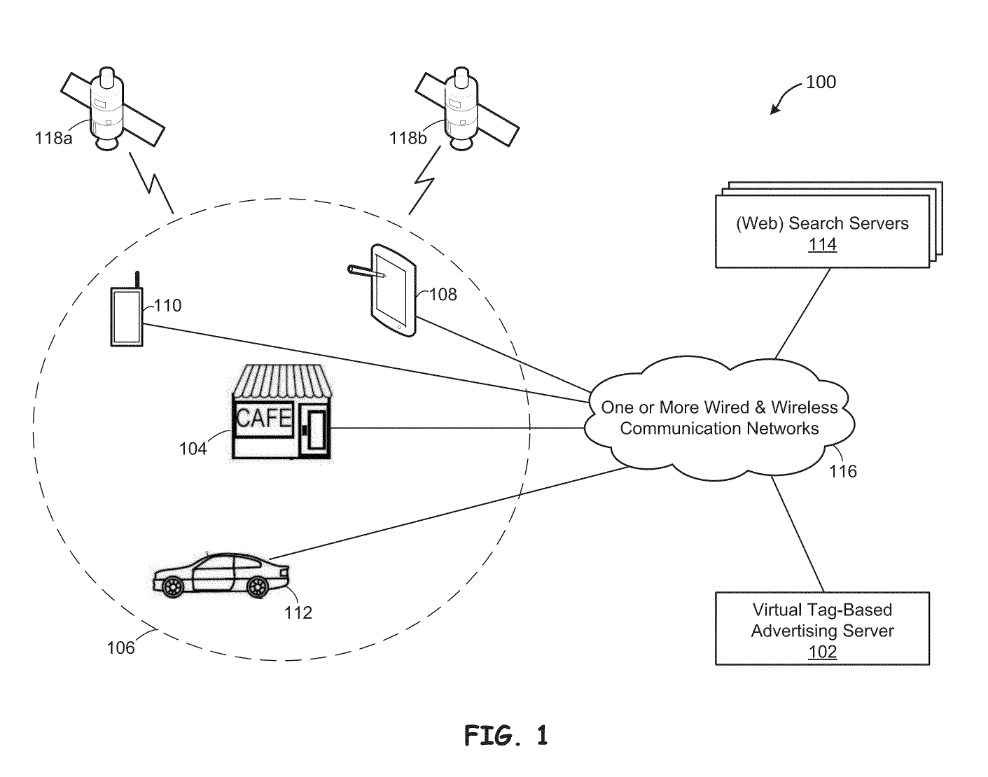

Referring more particularly to FIG. 1, a system diagram is shown of an example system 100 connecting a number of different devices and a target object via a tag-based advertising search engine. The illustrated embodiment includes a number of different devices (108-112) and a target object (merchant or café 104) configured to operate with one or more wired and wireless communication links 116, which may be one or more of a variety of networks such as described above. In this embodiment, the devices 108-112 may be mobile or stationary. In the particular example for system 100, device 108 is a tablet computer, device 110 is a mobile phone (e.g. cell phone, smartphone, etc.), and device 112 is a device affixed in a vehicle (e.g., a communication device or GPS navigation system with dual communication link). It is noted that other types of devices may be present within system 100.

The various devices within system 100 may have geographical location (geolocation) capabilities to determine the location of the respective devices on earth. In some instances, altitude information may be presented as part of the geolocation determination. In the example of system 100, devices 108-112 are shown linked to GPS satellites 118a and 118b to obtain GPS geolocation information. Timing signals from multiple such GPS satellites may be used to determine the geolocation of a device. In this example, devices 108-112 are all within a boundary 106 defining a geographical region or area encompassing a target object, in this instance a café (or coffee shop) 104.

The café 104 may have its own website with a unique URL, or some other means of providing a website, that allows the public to access the web site to obtain information relating to the café 104. The website may contain various types of information, such as available discounts, a menu, days and hours of operation, directions and other details dealing with the business operation of café 104. The website and its content may be located at café 104, but typically, the website may be managed at another location, and may be discoverable via one or more (web) search servers 114.

In a common scenario, when a user of a device, such as one of the devices 108-112, wants information about a merchant, eating establishment or coffee shop in a particular area, a search engine may be used to search for such business operations in an area (e.g., town, city or portions thereof). Assuming that café 104 pops up as part of the search, the searcher may then link to the website of café 104 to view information about the business at café 104. If specials or discounts are available, the user can then download appropriate e-coupons, etc.

In a similar scenario, a mobile device linked to GPS has the capability of identifying its location. Hence, when a search is conducted from such a geolocation capable device, the device may be capable of localizing the search to a proximate area. Thus, a person in a vehicle using device 112 may search for a coffee shop within a proximate area to the vehicle or a person using mobile phone 110 may search for a coffee shop within an area near the user's location. Mobile applications (apps) may be present on the device to make such searches simpler. For example, a chain coffee shop may support an application to identify a number of the chain's coffee shops within a pre-designated distance from the mobile device containing the application. Thus, a person wandering the streets of a city can quickly identify the nearest coffee shop for the chain of coffee shops.

Once café 104 is located by a mobile user, the mobile user may then access the café's website to obtain information about café 104. When an application is utilized, a link may be provided to allow the user to link to the website of café 104. The user may seek information about café 104, such as directions to the café 104, and may download e-coupons for discounts, etc.

Whether the user accesses the website by website searches or by geolocation tied to the location of the user's device, the access allows the user to connect to the website of café 104, or some equivalent location, to obtain information about café 104. When such a link is made to the café's website by the user to access the content of the website, the website may also provide a tag that sends an e-coupon, or some other means, to entice the user to visit café 104.

In a different scenario, café 104 may have the capability of identifying mobile devices that enter a pre-established boundary set for café 104. In system 100, boundary 106 is shown for café 104, so that devices within boundary 106 may be contacted to provide information (e.g., advertisements) regarding café 104. This process is different from the above-described scenarios in that the users of the various devices do not perform an active search for café 104.

For example, in an environment where a mobile device with geolocation capabilities is roaming, the device may be set to receive various geolocation or virtual tags. In one scenario, a mobile device may operate an application that allows a particular business to send a virtual tag to the mobile device. For example, a person attending a music festival in a particular city may download an application for the music festival that sends virtual tags pertaining to the various music venues. The same application or a different application may allow tags pertaining to eating and drinking establishments to be sent to the mobile devices.

In another scenario, a person may select to receive a particular class or type of virtual tag, or even all tags, pertaining to various businesses, venues, etc. within a locale or located within a certain distance from the mobile device. Such tag communications may be based on the location of the particular mobile device and its proximity to the location of the target object (such as café 104). Thus, such tags (e.g., geolocation tags, virtual tags or non-location specific tags) sent to the user may contain some indicator that a response is solicited when the person has some interaction with the target object. In the café example, such indicator may request confirmation of coupon redemption or product purchase, the person's review of the product procured at café 104, price paid for an item, quality of service provided, cleanliness of the premise, etc.

It is to be noted that advertising virtual tags may be hosted with the website content of café 104. However, in one embodiment, such tags are maintained in a virtual tag-based search engine/advertising server so that tags may be treated separately from the website content. In this manner, tags may be updated without updating the website content. In addition, tags may be sent separate from or without the website content. Hence, in the description above where tags are sent to roaming mobile devices, the tags may be tied to an entity that monitors the geolocation of a mobile device.

In system 100, a virtual tag-based advertising server 102 is used to provide advertising virtual tags to devices 108-112. As described in greater detail below, the virtual tags may be stored in a database and identified by a (tag) search engine based on a request. For example, if the initial connection is through a web search as noted above, a website connection may also link to a corresponding virtual tag in a tag database to send the corresponding tag to the searching device. If the virtual tag transmission is based on geolocation of the device (without website access), then the entity monitoring the location of the particular device accesses the corresponding virtual tag and sends the tag to the device. In some instances, the device, the monitoring entity and/or the target object may place certain constraints on the transmission of the virtual tag to the device.

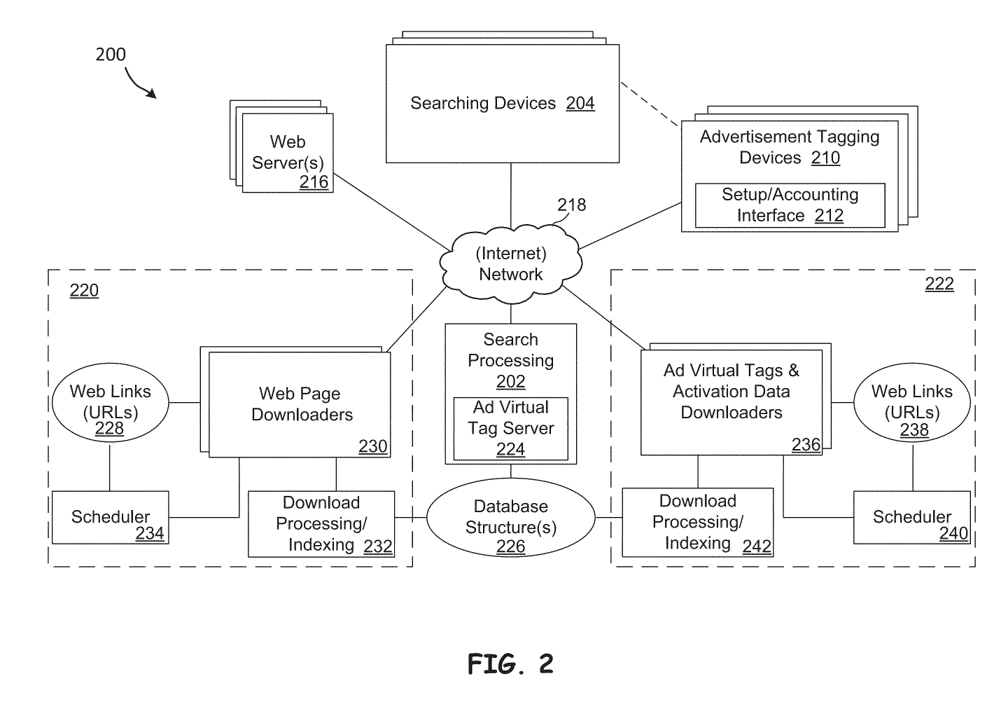

FIG. 2 is a block diagram of an exemplary search system 200 including virtual tagging capabilities. The illustrated search system 200 includes one or more search processing computers 202 (e.g., web-based servers) capable of identifying search results for provision to searching devices 204. As described further herein, the search processing computers 202 may further support an advertising virtual tag server 224.

In some embodiments, search results may be biased based, e.g., on either or both of hardware and software characteristics of the searching devices 204. Biasing of search results may include, for example, individual ones or combinations of (re)ranking, sorting, filtering, culling, restricting, and other tailoring operations that favor search results that are compatible with or may be consumed by recipient devices, or (using predictive operations) are most likely to be consumed by recipient devices. It is noted that in certain embodiments, biasing operations may entail selectively searching and generating results from search databases and/or portions of search databases that are selected, weighted, etc., based on data associated with a recipient device. Searching devices 204 may further include search-enabled program code or application software (e.g., a tag-based search interface in a web browser or media player) for generating search queries and receiving search results.

In the illustrated embodiment, a web crawler 220 systematically browses or “crawls” the World Wide Web hosting servers for the purpose of building a database of web-based content. Web crawler 220 uses a list of web links 228, such as URLs, as seeds for a process of content discovery. As the crawler visits these URLs, one or more web page downloader(s) 230 parse the URLs to identify unique hyperlinks in the page which point to content stored in web servers 216. URLs are typically visited in a recursive manner according to a set of policies which detect structure and content. As links are traversed, web pages and specific content are downloaded by downloader(s) 230 as per a schedule dictated by scheduler 234.

A download processing/indexing module(s) 232 operates to perform reverse indexing of a selected web page to encode web page words (e.g., based on frequency) and note location on the associated page (offset) so that content can be recovered or extracted at a later time. The indexed data is transferred to a search engine database structure(s) 226, where it is stored for later access by the search processing computers 202. In various embodiments of the present disclosure, search processing computers 202 receive Hypertext Transfer Protocol (HTTP) sequences and/or user input search strings from a searching device 204 (e.g., smartphone, tablet, laptop, desktop computer or other known or future client devices with communications capabilities) and parses/hashes database structure(s) 226 to retrieve, for example, data, text, images, video, software, links, etc.

Briefly, database structures 226 typically include indexes of unique words with associated index pointers (URLs) and web page position information. Unique words are hashed using a hash table. A hash table (or hash map) is a data structure used to implement an associative array, a structure that can map keys to values. A hash table uses a hash function to compute an index into an array of buckets or slots, from which the correct value can be found. Unique words are typically arranged by frequency (e.g., highest to lowest) and also carry importance based on a frequency ranking In a search context involving the phrase “the cat”, for example, the word “the” is generally not important while the word “cat” is important. Rare words are often given highest importance along with strings of words and rare strings of words.

Various elements of search system 200 are interconnected by a network 218 (e.g., an Internet backbone network) that is implemented using known and future communication infrastructures such as wireless and wired networks including, but not limited to, wireless local area networks (WLANs), wide area networks (WANs), local area networks (LANs), Ethernet, fiber optic or other known or future communication network infrastructures. Web servers 216 are accessible via the network 218, and host various web pages and associated content processed by the web crawler 220 and the search processing computers 202.

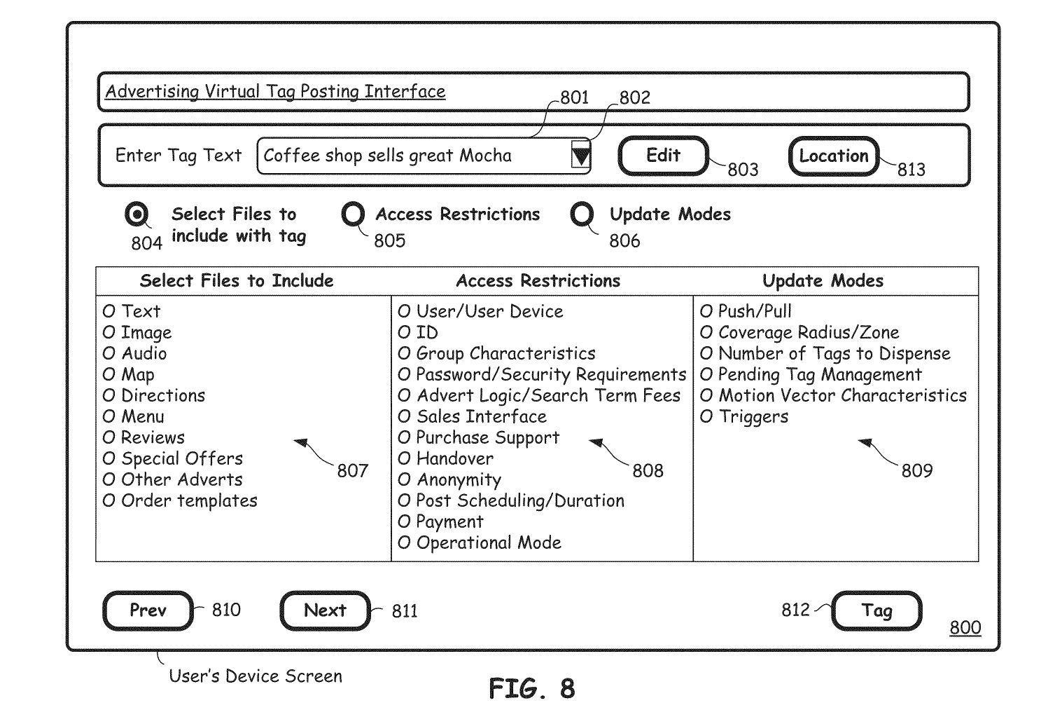

A (advertising) virtual tag crawling system 222 may also be provided to access and process local or private content in support of tag searching and retrieval operations. Such local content might include, for example, virtual tags, tag activation data, and related information/content established by a merchant or service provider. This content may or may not be available in a markup language format, e.g., HTML or XHTML. In the illustrated embodiment, advertisement tagging devices 210 may be utilized to generate such content via, for example, a setup/accounting interface 212 such as described in conjunction with FIG. 8.

In operation, the virtual tag crawling system 222 performs in a like manner to the web crawler 220. For example, the virtual tag crawling system 222 can access and parse stored advertisement virtual tags in much the same way a traditional web crawler would crawl a web page. The illustrated virtual tag crawling system 222 includes, but is not limited to: one or more advertising virtual tag and tag activation data downloader(s) 236; links or pointers 238 (such as URLs or global network routes (GNRs)) which identify unique routes that will guide a future search request to relevant content or portions of content; scheduler 240 to schedule the crawling of the virtual tags and related data; and a download processing/indexing module(s) 242 to process and (reverse) index data and content for storage in databases such as database structure(s) 226.

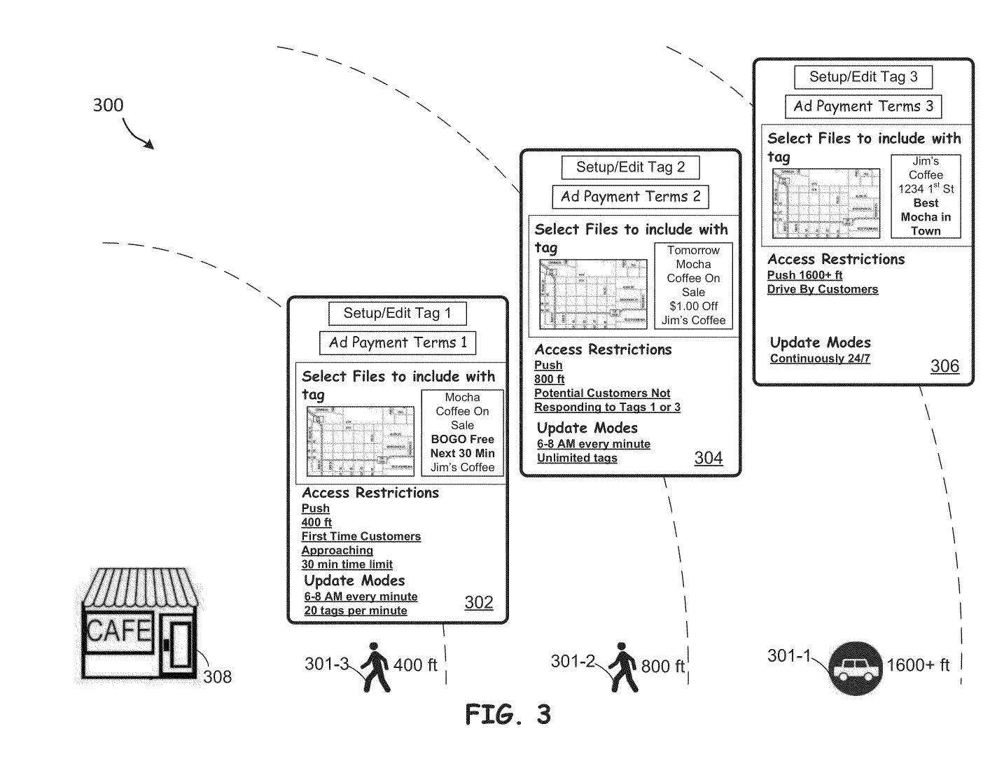

FIG. 3 shows an exemplary scenario 300 for receiving advertising virtual tags 302-306 based on geo-proximity to a posting target. The advertising virtual tags 302-306 may be generated via an advertising virtual tag posting interface. Each such advertising virtual tag may have associated and distinct ad payment or placement terms/fees.

As illustrated, a posting target or business (e.g., café 308) desires to attract customers through advertising virtual tags. The business creates one or more advertising virtual tags using a (local or remote) computing device with communications capabilities allowing it to connect with a search system such as shown in FIG. 1. In this example, a user 301-1 with a mobile communications device (e.g., a smartphone or other such device held by the user in an automobile) approaches business 300 at specified radial distance (e.g., 1600 ft.). Upon detection, the advertising virtual tag 306 is either pushed or pulled (e.g., by searching) to the user at this distance if the advertising virtual tag 306 has a selected coverage/activation area in this range. If the created advertising virtual tag has a smaller radial distance coverage/activation area (e.g., 800 ft.), user 301-2 receives the advertising virtual tag 304 upon entering the specified area. If the radial range is even smaller (e.g., 400 ft.), the advertising virtual tag (302) is received by user 301-3 upon entering the specified range.

It is noted that the advertising virtual tags 302, 304 and 306 may include different or partially overlapping advertising content, such as targeted coupons for enticing users from different distances. Further, users 301-1, 301-2, and 301-3 are, in various embodiments, the same customer as they approach business 300, different users or a combination thereof. For illustration purposes, the system is shown with three users, but the disclosed technology is not limited to a specific number of users.

In various embodiments, an advertising virtual tag may incorporate a map or other graphical directions to a target object and/or an advertisement including directional information (such as time-to-distance and a direction arrow or footstep pathway). In some embodiments, a map might include competitive route presentations. For example, route options may be shown in differing degrees of brightness, with cost functions employed to determine preferred routes. In addition, route presentations may be refreshed on a continual or periodic basis. Activation areas may be adjusted based on any of the above.

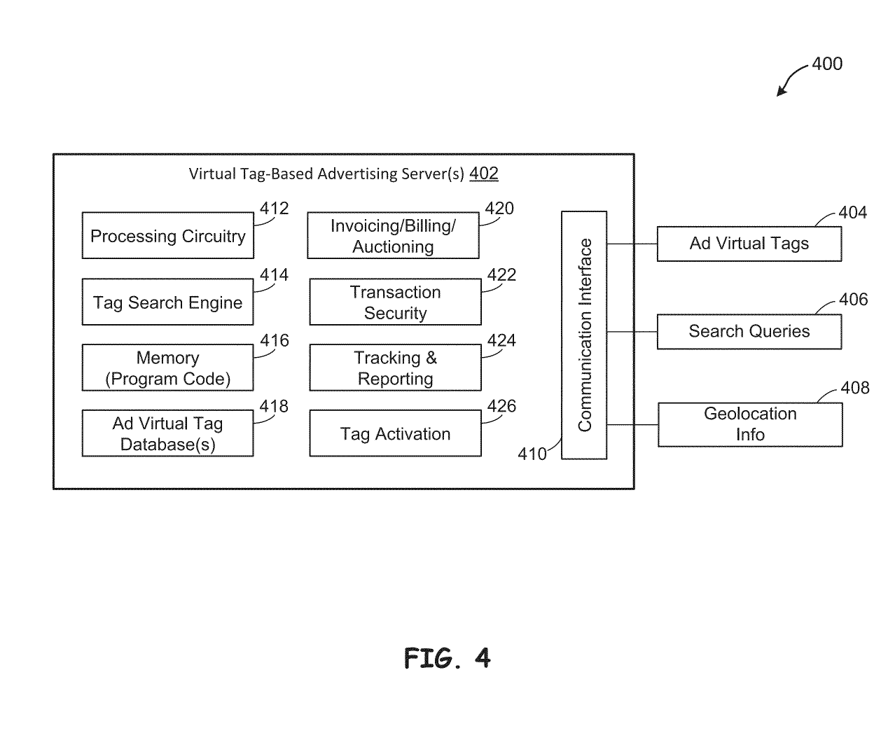

FIG. 4 is a block diagram of an exemplary virtual tag-based advertising system 400 that supports fee-based activation ranging and triggering. In this example, a virtual tag-based advertising server 402, which may be local, remote or combinations thereof, is operable to output and/or receive advertising virtual tags 404, search queries 406, and related geolocation information 408 via a communication interface 410.

In the illustrated embodiment, the advertising server 402 includes processing circuitry 412, a virtual tag search engine 414, memory 416 for storing both program code utilized by the processing circuitry 412 and other data relating to server operations, and one or more advertising virtual tag databases 418.

In addition, the illustrated advertising server 402 includes various functionality/modules for supporting fee-based advertising services. In particular, an invoicing, billing and auctioning module 420 is provided to support advertising fee billing and invoicing. The module 420 may perform other services, such as supporting competitive bidding for activation areas, search terms and phrases, search categories, etc. Such services may be securely performed through use of various security functions provided by transaction security module 422.

In various embodiments, the advertising server 402 also includes a tracking and reporting module 424 configurable to track various types of fee-based virtual tag operations performed by a poster or tag recipient, such as pay-per-click events, pay-per-view/impression events, and similar targeted actions. The tracking and reporting module 424 may perform other functions such as measuring and generating advertising/marketing campaign statistics for use by advertisers. A tag activation module 426 is also provided for performing tag activation and monitoring operations (e.g., utilizing geolocation information relating to tag recipient devices).

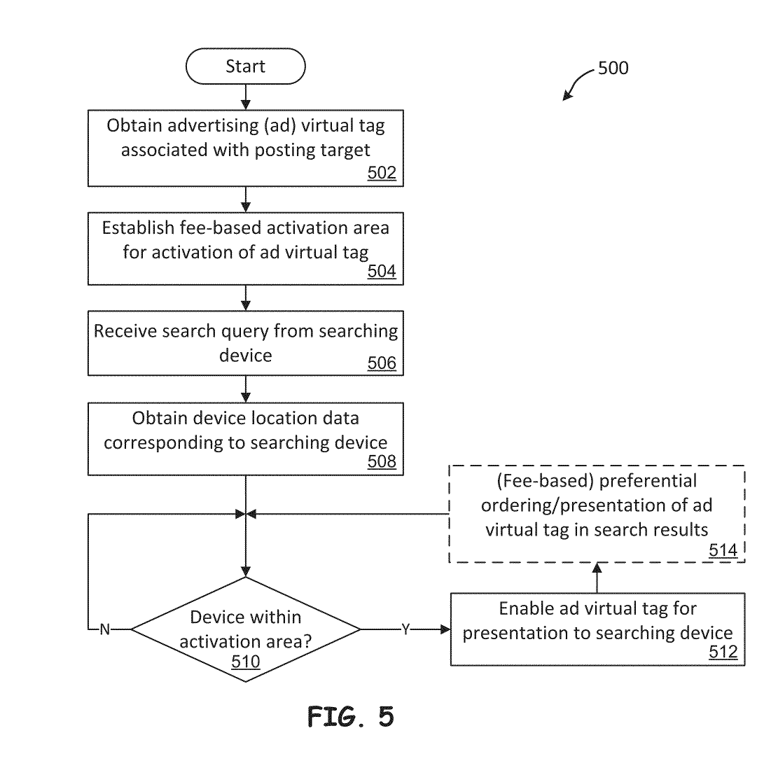

Referring now to FIG. 5, an operational flow diagram illustrating an exemplary method 500 for activating an advertising virtual tag for presentation with search query results is shown. In this method, an advertising virtual tag associated with a posting target is obtained (502) via a virtual tag posting interface or other means. Next, a fee-based activation area for activation of the advertising virtual tag is established (504). Upon receiving a related (or, in some embodiments, unrelated) search query from a searching device (506), device location data corresponding to the searching device is also obtained (508). In certain embodiments, the device location data may be part of or transmitted in conjunction with the search query.

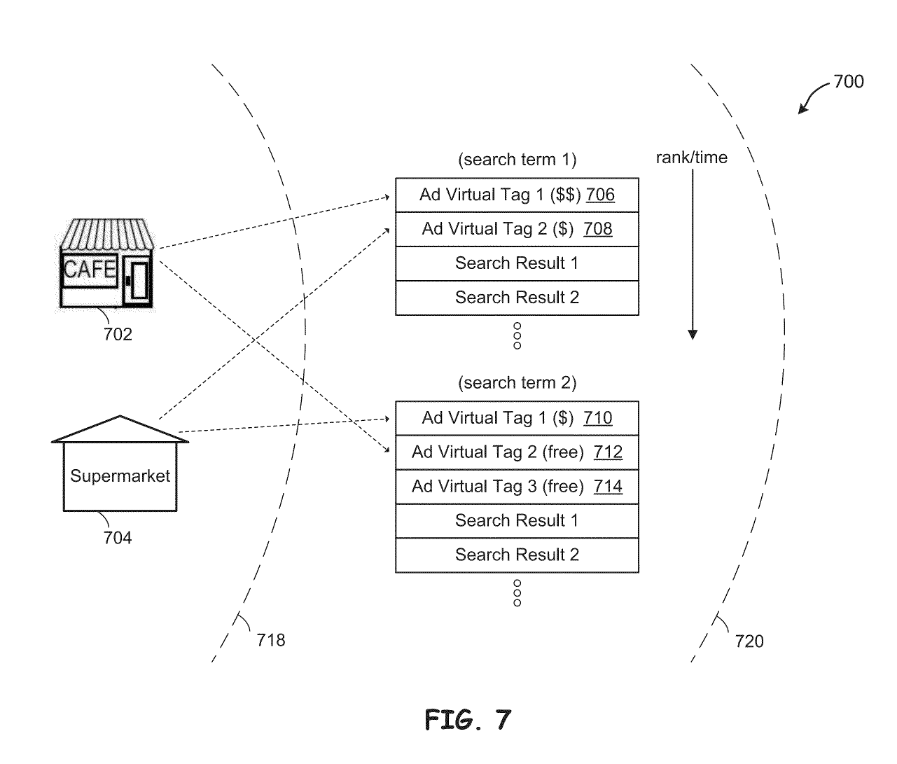

Next, the device location data is analyzed to determine if the device is within the action area (510). If so, the advertising virtual tag is enabled or communicated for presentation on the searching device (512). In the illustrated embodiment, the advertising virtual tag may receive (fee-based) preferential ordering/presentation in a set of search results (514), such as described in conjunction with FIG. 7.

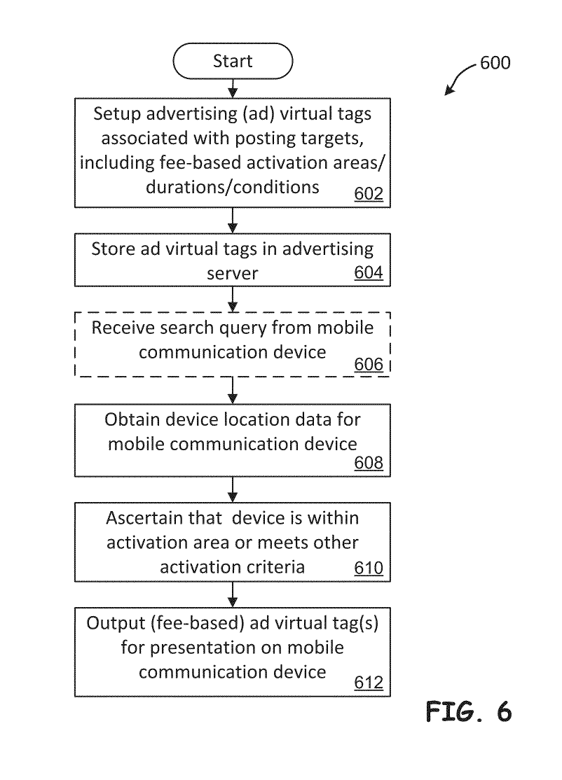

FIG. 6 is an operational flow diagram illustrating an exemplary method 600 for proximity-based activation of an advertising virtual tag by an advertising server. In this method, tag posters (e.g., merchants) generate advertising virtual tags associated with posting targets (602). Tag setup may include establishing fee-based activation areas, activation time durations, as well as other activation conditions. Once created, such advertising virtual tags are stored in an advertising server(s) (604) for authorized provision to mobile searching devices and the like. In some embodiments, such as described elsewhere herein, advertising virtual tags may be provided in response to a search query received from a mobile communication device (606).

Next, device location data corresponding is obtained for a mobile communication device (608). Based on this location data, a determination is made that the mobile communication device is within an activation area or meets other activation criteria (610). Following such a determination, one or more advertising virtual tags are output for presentation on the mobile communication device.

FIG. 7 is a system diagram of an example scenario 700 in which advertising virtual tags for merchant locations are ordered according to associated advertising fees. In this example, different combinations of search results (which may correspond to different search terms, search categories, etc.) are illustrated. In particular, fee-based advertising virtual tags associated with a first poster (café 702) and a second, geo-proximate poster (supermarket 704) are shown. In this embodiment, the search results are provided to a device (not shown) located between a first activation range/area 718 and a second activation range/area 720.

Upon receipt of a search query including a first search term, for example, through payment of higher fees an advertising virtual tag 706 associated with café 702 may receive preferential ordering/ranking/placement (e.g., when displayed in conjunction with a listing of search results) as compared to a similar advertising virtual tag 708 from supermarket 704. For results associated with a different search term, the supermarket might pay a fee for preferential ordering or placement of advertising virtual tag 710 as compared to a free advertising virtual tag 712 generated by café 702 or an advertising virtual tag 714 from another merchant.

With respect to advertising fees, a poster may be offered an option to extend the default maximum range by assessing fees (e.g., flat per month fees, view count fees, search result count fees, etc.). In certain embodiments, fee ceilings may be established, beyond which there is a reversion to default activation conditions. In addition, hosting of advertising virtual tags beyond certain posting content sizes/volumes/durations may be on paid basis. In other examples, only a validated brick and mortar business may be permitted to extend tag activation beyond default ranges/areas. Further, assessed fees may have a direct correlation to the size of a related activation area.

In still further embodiments, posters may compete for favorable virtual tag placement in specific activation ranges/areas. Such competition might involve, for example, an auction or bidding process for a particular activation area or tag-related search terms and/or other search parameters. Categories of advertisements may be allowed to operate in the same region, and category pricing might be based on past location performance. In some embodiments, payment of fees might allow blocking of or reduced activation areas for other advertising virtual tags in an area where tags from competitors might otherwise be displayed.

In addition to paying for continuous control of a large activation region for given advertising classifications or search query terms, time duration sequencing might be employed. For example, a soft drink manufacturer might pay for preferential treatment in the “soft drink” classification for the first five minutes that advertising virtual tags are displayed in a given region, but afterwards competitors' virtual advertising tags may be allowed to activate, or the fees assessed to the soft drink manufacturer may be reduced to a lower cost default fee schedule. Moreover, current key word/term type advertising approaches that form the basis for some search infrastructure functionality may be adopted or modified to support such virtual tagging operations.

FIG. 8 is a screen shot illustrating an example advertising virtual tag posting interface 800. In this example, various embodiments are shown for creating advertising virtual tags using the advertising virtual tag posting interface 800 (such as may be displayed on a user's device screen). The posting interface 800 includes fields for entering advertising virtual tag text 801 or, alternatively, selecting previously-entered text from a drop-down list (802) and editing such text (803). Previously-entered text may have been provided, for example, by the tag poster, a third party and/or tag templates. While text is shown, other forms of content are within the scope of the technology described herein, such as images, video, audio, music, etc. A basic advertising virtual tag may automatically include the text and geolocation (813) associated with the virtual tag. In various embodiments, a user may select location button 813, which automatically attaches the location of the user's device (using techniques such as the device's GPS coordinates, look-up address, or equivalent known or future techniques) or provides the user with a text box to input a location or select a location from either a list or map.

In addition, in various embodiments, it is possible to add one or more files 807 to the advertising virtual tag during creation (using button 804). Such files 807 may include, but are not limited to: text, images (e.g., pictures or video), audio (such as music or ring tones), maps, directions, menus, reviews, specials, advertising, order templates, purchase templates, etc.

In the illustrated embodiment, access restrictions (via button 805) on the advertising virtual tag may also be selected. Specific access restrictions 808 include, but are not limited to: enabling one or more specific users/devices; identity (ID) restrictions; group characteristics restrictions; password/security requirements; advertising logic selections (including attract mode behaviors and/or search term fees); sales interfacing selections/behaviors; purchase support selections; handover selections; anonymity settings; post scheduling and duration; payment options for associated advertising fees (incoming or outgoing); operational modes (e.g., client hosting without caching, search system hosting or shared hosting); etc.

In various embodiments, the advertising virtual tag posting interface 800 enables various update modes (via button 806) for an advertising virtual tag. Specific update modes 809 include, but are not limited to: push, pull (search retrieves advertising virtual tag in search results), periodic pull (user device periodically pulls available advertising virtual tags), and combinations thereof; a numerical or mapping interface that allows a poster to define either an activation coverage radius or other geographical coverage zone (with possible assistance based on historical data illustrating the likely performance of a tag on a geographical basis); auto shut-down/pause behaviors (e.g., dispense a certain number of advertising virtual tags per day/in total); pending tag management to turn off or add more advertising virtual tags; motion vector characteristics; and triggers.

Interface selections “previous” (810) and “next” (811) enable traversing a list of sequential or related advertising virtual tags. It is noted that a basic advertising virtual tag will typically comprise at least an annotation and location information. Additional virtual tag criteria selections, while not strictly required, may provide a more sophisticated, and possibly more effective, advertising virtual tag as the target audience is narrowed and/or focused.

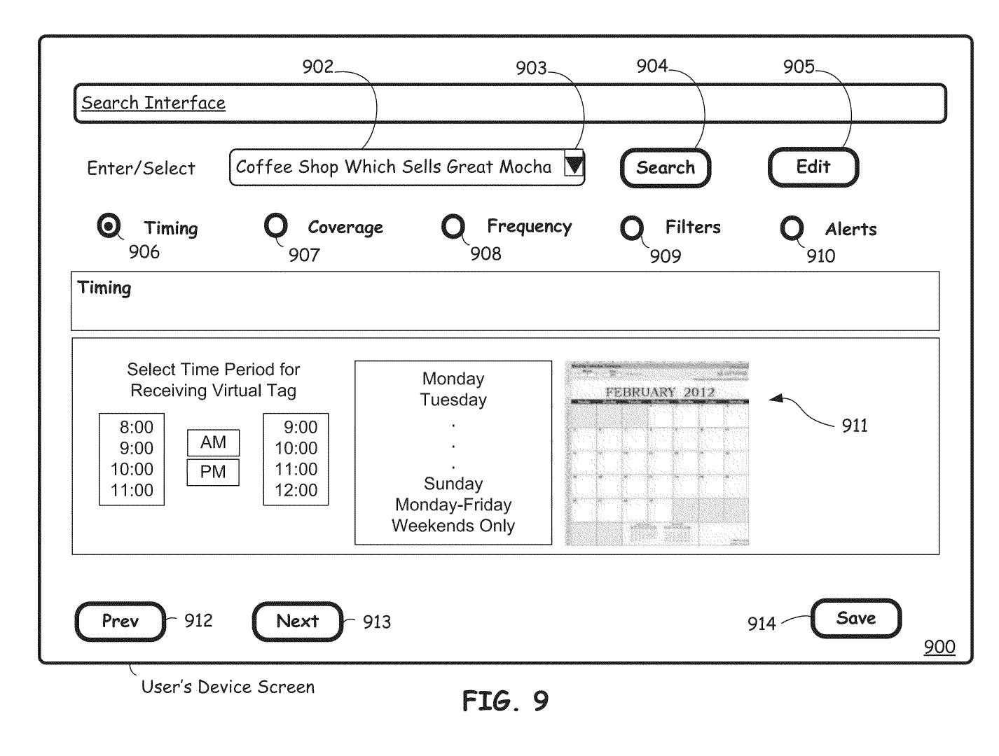

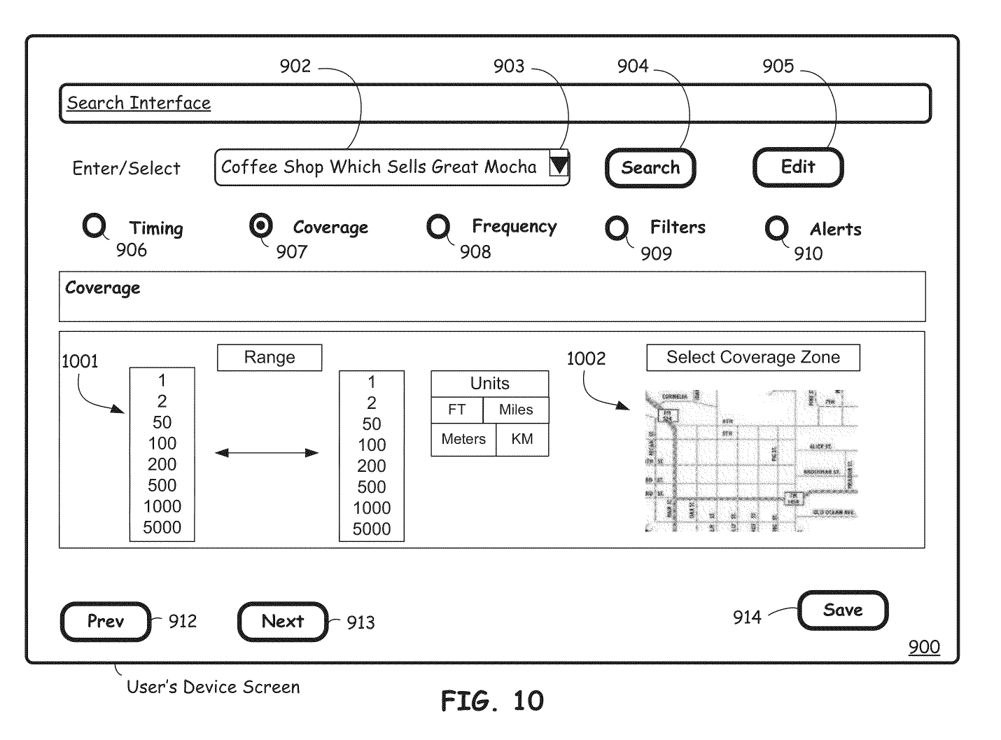

FIGS. 9 and 10 are screen shots illustrating an exemplary virtual tag search interface 900. Referring first to FIG. 9, the search interface 900 enables a user to specify various parameters for receipt of advertising virtual tags. This may be useful, for example, when a user is confronted with a large number of advertising virtual tags of varying degrees of interest, and the user wishes to refine, modify and/or limit the number of virtual tags received by a device.

In the illustrated embodiment, a mobile communication device user may refine results by adding search annotations (902) including text, video, image, audio, code, etc. Previously selected annotations may be used via a drop-down list (903). In certain embodiments, the user may be able to search (904) and edit (905) other annotations. Various other restrictions might be employed, including timing (906), coverage area (907), frequency (908), filters (909) and alerts (910). With respect to timing, for example, timing preferences 911 may include specific times or time periods during which virtual tags may be viewed or activated. For example, a user may select a specific time to view virtual tags (using only a first column time selection), or a time period selected from both a first and second time column. In addition to specific times, a user may select specific days of the week, a typical work week (M-F), weekends only (Sat/Sun), and/or a particular date from a calendar.

Referring briefly to FIG. 10, exemplary coverage restriction options for display/activation of virtual tags is illustrated. In the illustrated example, such options may include, without limitation, establishing a user-defined range 1001 and/or one or more contiguous and non-contiguous coverage zone/activation areas 1002. In some embodiments, filter tools may also be defined and applied to increase the likelihood that activated virtual tags will be of interest. Such filter tools may include various settings that reject virtual tags that fall outside certain parameters. Likewise, frequency capping might be employed to limit the number of times a virtual tag is displayed, the number of times a virtual tag is displayed within a specific time period, etc.

As may be used herein, the term “associated with”, includes direct and/or indirect association of separate items and/or one item being embedded within another item. As may also be used herein, the term(s) “operably coupled to”, “coupled to”, and/or “coupling” includes direct coupling between items and/or indirect coupling between items via an intervening item (e.g., an item includes, but is not limited to, a component, an element, a circuit, and/or a module) where, for indirect coupling, the intervening item does not modify the information of a signal or communication. As may further be used herein, inferred coupling (i.e., where one element is coupled to another element by inference) includes direct and indirect coupling between two items in the same manner as “coupled to”. As may even further be used herein, the term “operable to” or “operably coupled to” indicates that an item includes one or more of power connections, input(s), output(s), etc., to perform, when activated, one or more its corresponding functions and may further include inferred coupling to one or more other items.

As may also be used herein, the terms “processing module”, “processing circuit”, and/or “processing unit” may be a single processing device or a plurality of processing devices. Such a processing device may be a microprocessor, micro-controller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, and/or processing unit may be, or further include, memory and/or an integrated memory element, which may be a single memory device, a plurality of memory devices, and/or embedded circuitry of another processing module, module, processing circuit, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, and/or processing unit includes more than one processing device, the processing devices may be centrally located (e.g., directly coupled together via a wired and/or wireless bus structure) or may be distributed (e.g., cloud computing via indirect coupling via a local area network and/or a wide area network). Further note that if the processing module, module, processing circuit, and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, and/or processing unit executes, hard coded and/or operational instructions corresponding to at least some of the operations and/or functions illustrated in one or more of the Figures. Such a memory device or memory element can be included in an article of manufacture.

The present disclosure includes method descriptions illustrating the performance of specified functions and relationships thereof. The boundaries and sequence of these functional building blocks and method operations have been defined herein for convenience of description. Alternate boundaries and sequences can be defined so long as the specified functions and relationships are appropriately performed. Any such alternate boundaries or sequences are thus within the scope and spirit of the claims. Similarly, flow diagram blocks may also have been defined herein to illustrate certain significant functionality. To the extent used, the flow diagram block boundaries and sequence(s) could have been defined otherwise while still performing the certain significant functionality. Such alternate definitions of both functional building blocks and flow diagram blocks and sequences are thus within the scope and spirit of the claimed subject matter. One of average skill in the art will also recognize that the functional building blocks, and other illustrative blocks, modules and components herein, can be implemented as illustrated or by discrete components, application specific integrated circuits, processors executing appropriate software and the like or any combination thereof.

The present disclosure may have also been described, at least in part, in terms of one or more embodiments. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

Unless specifically stated to the contrary, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of the various embodiments of the present disclosure. A module includes a processing module, a functional block, hardware, and/or software stored on memory for performing one or more functions as may be described herein. Note that, if the module is implemented via hardware, the hardware may operate independently and/or in conjunction with software and/or firmware. As used herein, a module may contain one or more sub-modules, each of which may also contain one or more sub-modules.

While particular combinations of various functions and features of the present disclosure have been expressly described herein, other combinations of these features and functions are likewise possible. The present disclosure is not limited by the particular examples disclosed herein and expressly incorporates these other combinations.

What is claimed is:

1. A method for supporting location-based advertising, the method comprising:
obtaining an advertising virtual tag associated with a posting target, the advertising virtual tag having associated geolocation information relating to the posting target;
establishing a fee-based activation area for activation of the advertising virtual tag;
receiving a search query from a searching device;
obtaining device location data corresponding to the searching device;
based at least in part on the device location data, ascertaining that the searching device is within the activation area; and
enabling activation of the advertising virtual tag for presentation to the searching device within the activation area.

2. The method of claim 1, wherein enabling activation of the advertising virtual tag includes:
outputting the advertising virtual tag and a set of search results corresponding to the search query.

3. The method of claim 2, wherein presentation of the advertising virtual tag to the searching device includes preferential ranking of the advertising virtual tag in the set of search results.

4. The method of claim 2, wherein
outputting the advertising virtual tag further includes outputting a plurality of advertisements including the advertising virtual tag, and
presentation of the advertising virtual tag to the searching device includes preferential ordering of the advertising virtual tag within the plurality of advertisements.

5. The method of claim 1, further comprising:
identifying at least one search term or category relating to the advertising virtual tag; and
charging a fee for preferential placement of the advertising virtual tag when the search query includes the at least one search term or category.

6. The method of claim 1, wherein the fee-based activation area includes a geographical region encompassing the posting target.

7. The method of claim 6, wherein the advertising virtual tag includes graphical directions to the posting target based, at least in part, on the device location.

8. The method of claim 1, wherein enabling activation of the advertising virtual tag is for a predetermined time duration, the time duration having an associated advertising fee.

9. The method of claim 1, wherein the posting target is a service provider location or a merchant location.

10. The method of claim 9, wherein the advertising virtual tag identifies at least one of a service offered by the service provider or an item of merchandise offered at the merchant location.

11. The method of claim 1, further comprising:
establishing a second fee-based activation area for activation of the advertising virtual tag;
ascertaining, based at least in part on the device location data, that the searching device is within the second activation area; and
enabling activation of the advertising virtual tag for presentation to the searching device within the second activation area.

12. A method performed by a search service to support location-based advertising, the method comprising:
maintaining a plurality of advertising virtual tags associated with a respective plurality of posting targets, the advertising virtual tags including associated geolocation information;
establishing at least one fee-based activation area for activation of advertising virtual tags;
obtaining device location data corresponding to a mobile communication device;
based at least in part on the device location data, ascertaining that the mobile communication device is within the activation area; and
outputting at least one of plurality of advertising virtual tags for presentation on the mobile communication device within the activation area.

13. The method of claim 12, the plurality of advertising virtual tags maintained in an advertising server.

14. The method of claim 13, wherein establishing at least one fee-based activation area for activation of the advertising virtual tag involves an auction process.

15. The method of claim 12, wherein the fee-based activation area includes a geographical region encompassing at least one of the posting targets.

16. The method of claim 12, wherein activation of advertising virtual tags is for a predetermined time duration, the time duration having an associated advertising fee.

17. An advertising system, comprising:
a communication interface configured to operate via a network to communicate with a plurality of devices and to receive a search parameter and geolocation information relating to a first device; and
an advertising server operably coupled to the communication interface, the advertising server including:
processing circuitry;
memory coupled to the processing circuitry, the memory storing a plurality of advertising virtual tags associated with a respective plurality of posting targets; and
program code stored in the memory, wherein the processing circuitry operates according to the program code to:
support a fee-based activation area for activation of at least one of the plurality of advertising virtual tags;
ascertain, based at least in part on received geolocation information, that the first device is within the activation area; and
enable activation of the advertising virtual tag for presentation to the first device within the activation area.

18. The advertising system of claim 17, wherein activation of the advertising virtual tag includes interacting with a search server to provide the advertising virtual tag to the first device in conjunction with search results that correspond to the search parameter.

19. The advertising system of claim 17, wherein the fee-based activation area is established, at least in part, based upon setup information received via the communication interface from an accounting user interface.

20. The advertising system of claim 17, the advertising server receiving periodic updates to the geolocation information via the communication interface.
